(19) United States
(12) Patent Application Publication
(10) Pub. No.: US 2026/0194017 A1
(43) Pub. Date: Jul. 9, 2026

(54) HYDRAULICALLY DRIVEN FLUID INJECTION SYSTEM WITH ACTIVE FILL CONTROL

(71) Applicant: Hamilton Sundstrand Corporation, Charlotte, NC (US)

(72) Inventors: Ryan Prescott Susca, Windsor, CT (US); August M. Coretto, Windsor, CT (US); Michael Ferrarotti, Durham, CT (US); Liana Frangioni, Bloomfield, CT (US); Thomas Joseph Seeley, Bristol, CT (US)

(21) Appl. No.: 19/441,354

(22) Filed: Jan. 6, 2026

Related U.S. Application Data
(60) Provisional application No. 63/742,225, filed on Jan. 6, 2025.

(51) Int. Cl. F02C 9/26; F02C 7/232

(52) U.S. Cl. CPC F02C 9/263; F02C 7/232

(57) ABSTRACT

Apparatus and associated methods relate to a fuel-metering subsystem configured to provide active filling of a fuel line with a secondary fuel. The fuel-metering subsystem is in fluid communication with fuel-pressurizing subsystem, which is hydraulically powered by a primary fuel. The fuel-metering subsystem includes a low-flow fluid path between the output orifice of the pressure regulating valve and an injector port. The low-flow fluid path including a metering orifice. The fuel-metering subsystem includes a high-flow fluid in parallel with the low-flow fluid path. The high-flow fluid path including a fill solenoid having an open and a closed position, wherein, with the fill solenoid in the open position, flow resistance of the high-flow fluid path is less than a flow resistance of the low-flow fluid path, thereby enabling active delivery of fuel in response to opening of the fill solenoid.

### BACKGROUND

Dual fuel systems can be used to enable a gas turbine engine to operate with multiple fuel sources. Dual fuel engines may be advantageous for various reasons. For example, as the aircraft gains in altitude, it may be advantageous to operate the engine on a different fuel that is able to function in a low oxygen environment. Alternatively, a secondary fuel may be desirable to minimize the impact of contrails from the aircraft. Current dual-fuel systems operate with additional pumps, motors, and motor controllers. To reduce weight, there is a need to eliminate additional pumps, motors, and motor controllers to pressurize the secondary fluid.

### SUMMARY

Some embodiments relate to a secondary-fuel supply system with active fill capability. The secondary-fuel supply system includes a secondary-fuel reservoir having a piston separating a first chamber from a second chamber. The second chamber is configured to be filled with a secondary fuel. The first chamber is configured to be pressurized with a primary fuel, thereby causing the secondary fuel to be expelled from the second chamber. The secondary-fuel supply system includes a shut-off valve configured to selectively provide fluid communication between a pressurized primary fuel source and the first chamber of the secondary fuel reservoir. The secondary-fuel supply system includes a low-flow fluid path having a first flow resistance between the second chamber of the secondary-fuel reservoir and an injector port. The secondary-fuel supply system includes a high-flow fluid path in parallel with the low-flow fluid path. The high-flow fluid path has a fill solenoid having an open and a closed position. With the fill solenoid in the open position, a second flow resistance of the high-flow fluid path is less than the first flow resistance of the low-flow fluid path, thereby enabling active delivery of fuel in response to opening of the fill solenoid.

Some embodiments relate to a method for actively filling fuel lines with a secondary fuel. In the method, a command to provide a secondary fuel to the gas turbine engine is received by an engine controller. In response to receiving the command to provide a secondary fuel, the method performs the following steps: i) a signal configured to cause the shut-off valve to open is sent by the engine controller, thereby providing fluid communication between a pressurized primary fuel source and a first chamber of a secondary-fuel reservoir, which causes secondary fuel within a second chamber of the secondary-fuel reservoir to be pressurized via a piston positioned between the first and second chambers of the secondary-fuel reservoir; and ii) a signal configured to cause a fill solenoid to open is sent by the engine controller, thereby causing the secondary fuel to flow through a high-flow fluid path to the injector port. With the fill solenoid open, a second flow resistance of the high-flow fluid path is less than a first flow resistance of a low-flow fluid path that is in parallel with the high-flow fluid path, thereby enabling active delivery of fuel in response to opening of the fill solenoid.

### BRIEF DESCRIPTION OF THE DRAWINGS

FIG. 1 is a schematic diagram of a secondary fuel supply system configured to provide a secondary fuel to a gas turbofan engine.

FIG. 2 is a graph of flow rates as a function of time for active fill operation of a secondary fuel.

FIG. 3 is a flowchart depicting a method for actively filling fuel lines with a secondary fuel.

### DETAILED DESCRIPTION

Apparatus and associated methods relate to a fuel-metering subsystem configured to provide active filling of a fuel line with a secondary fuel. The fuel-metering subsystem is in fluid communication with fuel-pressurizing subsystem, which is hydraulically powered by a primary fuel. The fuel-metering subsystem includes a low-flow fluid path between the output orifice of the pressure regulating valve and an injector port. The low-flow fluid path including a metering orifice. The fuel-metering subsystem includes a high-flow fluid in parallel with the low-flow fluid path. The high-flow fluid path including a fill solenoid having an open and a closed position, wherein, with the fill solenoid in the open position, flow resistance of the high-flow fluid path is less than a flow resistance of the low-flow fluid path, thereby enabling active delivery of fuel in response to opening of the fill solenoid.

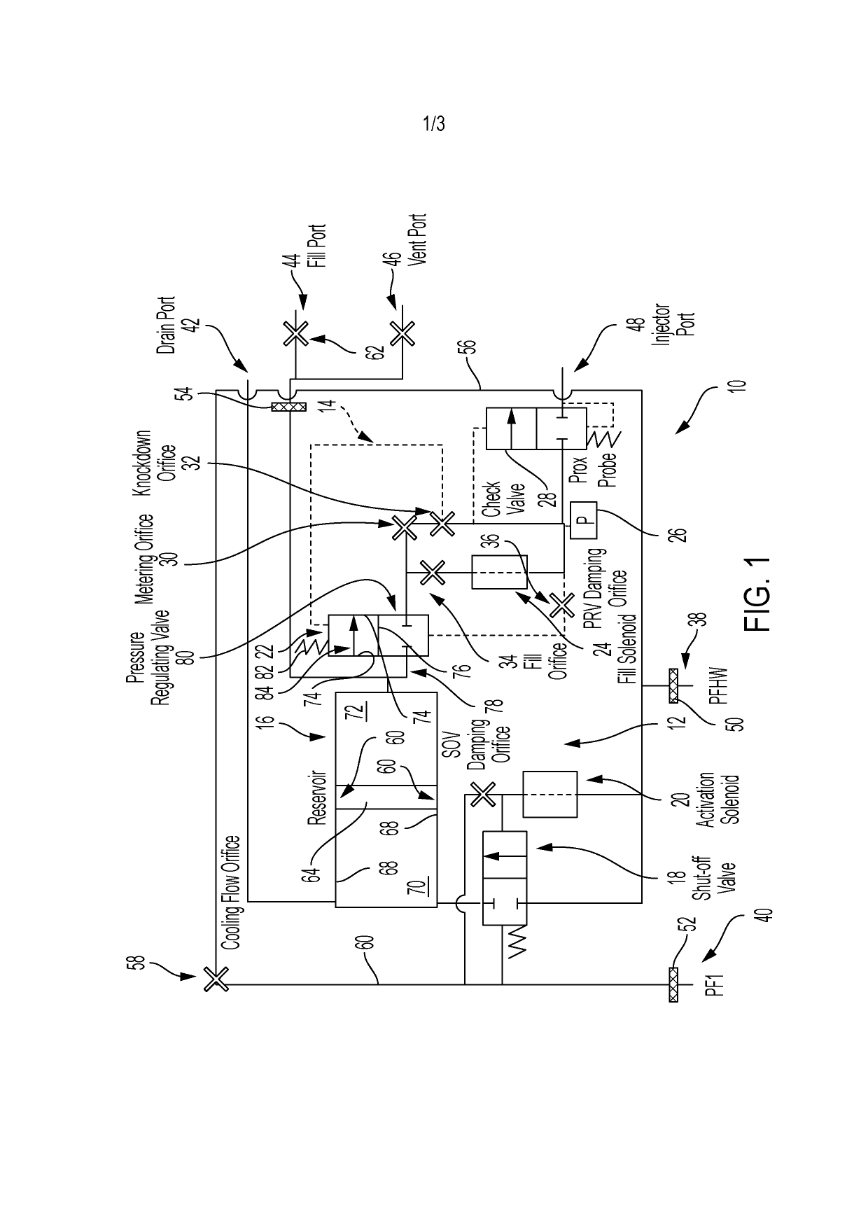

FIG. 1 is a schematic diagram of a secondary fuel supply system configured to provide a secondary fuel to a gas turbofan engine. In FIG. 1, secondary fuel supply system 10 includes fuel-pressurizing subsystem 12 and fuel-metering subsystem 14. Fuel-pressurizing subsystem 12 includes secondary fuel reservoir 16, shut-off valve 18 and activation solenoid 20. Fuel metering subsystem 14 includes pressure regulating valve (PRV) 22, fill solenoid 24, pressure sensor 26, check valve 28, metering orifice 30, knockdown orifice 32, fill orifice 34, and PRV damping orifice 36. Secondary fuel supply system 10 has various ports into which fuel can be drawn, and out of which air or fuel can be expelled, including primary inlet port 38, discharge port 40, drain port 42, secondary inlet port 44, vent port 46, and injector port 48. Secondary fuel supply system 10 also includes various filters, such as primary fuel filter 50, drain filter 52, and secondary fuel filter 54. Notably absent from secondary fuel supply system 10 are any pumps, motors, and/or motor controllers for generating pressures used for secondary fuel operations of a gas turbine engine. Instead, such pressures will be generated using the hydraulic power of a primary fuel supply system of the gas turbine engine, which will be described below.

In FIG. 1, secondary fuel supply system 10 receives a primary fuel from primary inlet port 38 and receives a secondary fuel from secondary inlet port 44. The primary fuel received from primary inlet port 38 is used by secondary fuel supply system 10 as a source of hydraulic fluid for facilitating control of delivery of the secondary fuel. The primary fuel can be provided to primary inlet port 38 by an external primary fuel source at a primary fuel pressure PFHW. The primary fuel may be cooled by routing the primary fuel through cooling loop 56. Cooling loop 56 uses the primary fuel to absorb heat from the secondary fuel, thereby preventing overheating of the secondary fuel. Cooling loop 56 may be routed through various engine systems to provide such cooling of the primary fuel. As indicated in the depicted embodiment, the primary fuel may be routed through cooling loop 56, to cooling flow orifice 58, through discharge line 60, and then through discharge port 40 to a fuel reservoir (not depicted). The pressure of the primary fuel at discharge port 40, may be at a pressure PF1, which may be lower than the pressure PFHW of the primary fuel located at primary input port 38, in part due to a pressure drop incurred as the primary fuel flows through cooling flow orifice 58. By selectively directing the primary fuel from these two locations – from primary inlet port 38, where the primary fuel may be at a relatively high pressure of PFHW, and from discharge line 60, where the primary fuel may be at a relatively low pressure of PF1 – various fueldraulic devices of secondary fuel supply system 10 can be operatively controlled.

The secondary fuel is provided to secondary inlet port 44 by an external secondary fuel source, typically when the gas turbine engine is off (e.g., while the aircraft is being prepared for flight). Secondary-inlet valve 62 selectively permits (e.g., by selectively opening and closing) the secondary fuel to be drawn into secondary fuel supply system 10. Secondary inlet port 44 is in fluid communication with secondary fuel reservoir 16 in response to secondary inlet valve 62 being opened. Opening secondary-inlet valve 62 permits the secondary fuel to be made to flow to secondary fuel reservoir 16 for storage therein and for subsequent distribution to the gas turbine engine. Secondary fuel reservoir 16 includes piston 64, which includes lands 66 which engage cylindrical wall 68, thereby separating first chamber 70 from second chamber 72. Second chamber 72 is configured to receive and expel the secondary fuel, and primary chamber 68 is configured to selectively receive primary fuel of different pressures so as to moveably operate piston 64. Piston 64 is movable within cylindrical wall 68 of secondary fuel reservoir 16 based on a pressure difference between pressures of the fluid (e.g., the primary fuel) within first chamber 70 and the fluid (e.g., the secondary fuel) within second chamber 72. As piston 64 moves, first chamber 70 expands or contracts in volume, while second chamber 72 contracts or expands, respectively, in a complementary fashion.

By selectively providing fluid communication between first chamber 70 and either primary inlet port 38, which has a fuel pressure of PFHW, or discharge line 60, which has a fuel pressure of PF1, the pressure difference across piston 64 can be alternately controlled to either PFHW-PINJECTION or PF1-PINJECTION, respectively. Because the pressure PINJECTION may be between the pressures PFHW and PF1 (i.e., PF1<PINJECTION<PFHW), the sign or direction of the differential pressure can be controlled so as to bidirectionally move piston 64 within cylindrical wall 68, thereby controlling the pressure difference between pressures of the fluid within first chamber 70 and the fluid within second chamber 72. When first chamber 70 is configured to be in fluid communication with discharge line 60, and secondary inlet solenoid 60 is opened, the pressure difference PF1-PINJECTION will be negative, as the pressure PINJECTION may be controlled to be greater than the pressure PF1. Such a negative pressure difference will cause piston 64 to move in a manner that reduces the volume of first chamber 70 as the primary fuel therein is expelled through drain port 42. In some embodiments, drain port 42 can be selectively opened and closed by a drain port solenoid (not depicted). As the volume of first chamber 70 is being reduced, the volume of second chamber 72 is increasing as the secondary fuel is being received therein. When secondary fuel reservoir 16 has been filled with secondary fluid (i.e., piston 64 has moved to a position where second chamber 72 has a maximum volume), secondary inlet solenoid 60 can be closed, thereby sealing secondary fuel within secondary fuel supply system 10. Conversely, when first chamber 70 is configured to be in fluid communication with primary inlet port 38, and secondary inlet solenoid 60 is closed, the pressure within first chamber 70 will be PFHW, which pressurizes the secondary fuel within second chamber 72 via piston 64. Second chamber 72 is also in fluid communication with fuel-metering subsystem 14, which can receive and meter the flow of the secondary fuel.

Shut-off valve 18 is configured to selectively provide the fluid communication between first chamber 70 and either primary inlet port 38 or discharge line 60. In the depicted embodiment, shut-off valve 18 is a spool valve, which has cylindrical walls 74, in which spool 76 is moveable in an axial direction (i.e., the direction parallel to the axes of cylindrical walls 74 and spool 76). Spool 76 has lands that engage cylindrical walls 74 of shut-off valve 18, thereby guiding spool 76 during such axial movement and selectively blocking fluid communication between apertures 78 and 80 in cylindrical walls 74. Apertures 78 and 80 are in fluid communication with first chamber 70 of secondary fuel reservoir 16 and primary inlet port 38, respectively.

Shut-off valve 18 includes spring 82, which provides a spring force to spool 76. The spring force provided by spring 82 to spool 76 is in a direction that forces spool 76 to a first axial position, in which fluid communication is blocked between first and second apertures 76 and 78 in cylindrical walls 74. To move spool 76 to a second axial position, in which spool 76 presents a chamber for fluid communication between apertures 78 and 80, a force in the opposite direction of and exceeding the spring force of spring 82 is applied to spool 76. Such a force can be provided to spool 76 using pressure of the fluid within control chamber 84 of shut-off valve 18.

Activation solenoid 20 is configured to selectively provide fluid communication between control chamber 84 of shut-off valve 18 and primary inlet port 38, where primary fuel has a pressure of PFHW. Activation solenoid 20 can be controlled by an engine controller, such as, for example, a Full Authority Digital Engine Controller (FADEC). For example, the FADEC, can cause activation solenoid 20 to selectively open or close. In some embodiments, the FADEC coordinates control of activation solenoid 20 with various other controllable components of secondary fuel supply system 10.

In response to being closed, activation solenoid 20 isolates control chamber 84 of shut-off valve 18 from primary inlet port 38. In such a configuration (i.e., activation solenoid 20 being controlled to a closed configuration), control chamber 84 of shut-off valve 18 is in fluid communication with discharge line 60 via cooling flow orifice 58. The primary fuel within control chamber 84 of shut-off valve 18 is at the pressure PF1 of discharge line 60, in response to activation solenoid 20 being controlled to the closed configuration. The spring force of spring 82 is typically greater than the force applied to spool 76 due to the pressure PF1 of primary fuel within control chamber 84. Thus, the pressure PF1 of primary fuel within control chamber 84 is insufficient to provide the force needed to move spool 76 to the second axial position, in which spool 76 presents a chamber for providing fluid communication between first chamber 70 of secondary fuel reservoir 16 and primary inlet port 38. In response to this configuration, the pressure PSO of the primary fuel in first chamber 70 of secondary fuel reservoir 16 is low – typically less than the pressure of the secondary fuel within second chamber 72 of secondary fuel reservoir 16. In some embodiments, the FADEC will simultaneously control activation solenoid 20 to be closed and control secondary inlet solenoid 60 to be opened so as to fill second chamber 72 of secondary fuel reservoir 16 with the secondary fuel. In some embodiments, the FADEC will then close secondary inlet solenoid 60 in response to filling the second chamber 72 of secondary fuel reservoir 16 with the secondary fuel so as to be ready to provide the secondary fuel to the gas turbine engine.

When the secondary fuel is to be provided to the gas turbine engine, the FADEC commands activation solenoid 20 to open. In response to being opened, activation solenoid 20 provides a path of fluid communication between primary inlet port 38 and control chamber 84 of reservoir control valve 16. In such a configuration (i.e., activation solenoid 20 being controlled to an open configuration), control chamber 84 of reservoir control valve 16 is in fluid communication with primary inlet port 38. The primary fuel within control chamber 84 of reservoir control valve 16 is at the pressure PFHW of primary inlet port 38, in response to activation solenoid 20 being controlled to the open configuration. The spring force of spring 82 is typically less than the force applied to spool 76 due to the pressure PFHW of primary fuel within control chamber 84. Thus, the pressure PFHW of primary fuel within control chamber 84 is sufficient to provide the force needed to move spool 76 to the second axial position, in which spool 76 presents a chamber for providing fluid communication between first chamber 70 of secondary fuel reservoir 16 and primary inlet port 38. The pressure PFHW of the primary fuel within first chamber 70 is then transferred through piston 64 to the secondary fuel within second chamber 72.

With the secondary fuel so pressurized, fuel-metering subsystem 14 can receive the secondary fuel from fuel-pressurizing subsystem 12, meter the received secondary fuel, and provide the metered secondary fuel to injector port 48, which is in fluid communication with fuel injectors of the gas turbine engine. Pressure regulating valve 22 is normally open so as to receive the secondary fuel from second chamber 72 of secondary fuel reservoir 16. Pressure regulating valve 22 then closes to throttle the pressure of the downstream system in response to such pressures exceeding a specified pressure level for fuel injection. When the secondary fuel is to be provided by secondary fuel reservoir 16 to the gas turbine engines, activation solenoid 20 is commanded open, which in turn causes shut-off valve 18 to provide fluid communication between the primary fuel source and first chamber 70 of secondary fuel reservoir 16. This results in pressurization of the primary fuel within first chamber 70 of secondary fuel reservoir 16. The secondary fuel within second chamber 72 of secondary fuel reservoir 16 is also pressurized via piston 64. The secondary fuel then flows from second chamber 72 of secondary fuel reservoir 16, through pressure regulating valve 22, to fill orifice 24 and metering orifice 30. Metering orifice 30 is configured to meter the flow of the secondary fuel. The fuel metered by metering orifice 30 then flows to knockdown orifice 32, across which a pressure differential of the secondary fuel results. The series configured metering orifice 30 and knockdown orifice 32 form first flow path P₁, which provides steady-state delivery of the secondary fuel to the gas turbine engine.

In parallel with flow path P₁ is second flow path P₂, which is configured to provide transient delivery of the secondary fuel to the gas turbine engine. Second flow path P₂ includes fill orifice 34 and fill solenoid 24. Fill solenoid 24 can be controlled by the FADEC so as to compensate for transient dips and peaks in the flow of the secondary fuel to the gas turbine engine. For example, when pressure regulating valve 22 opens or closes, the flow rate doesn’t respond immediately of the secondary fuel injected by the fuel injectors into the combustion chamber of the gas turbine engine, as the fuel lines to the fuel injectors must first be filled before any fuel can be subsequently delivered to the fuel injectors. To quickly fill these fuel lines, a large bolus of fuel can be provided at the beginning of delivery of the secondary fuel to the gas turbine engine. The volume of the bolus can be configured to be equal to the volume of fuel needed to fill empty fuel lines between injector port 48 and the fuel injectors of the gas turbine engine, for example. Fill orifice 34 is configured to meter the flow rate of such a bolus of the secondary fuel. Flow rate of the secondary fuel through second path P₂ is much greater than the flow rate of the secondary fuel through first flow path P₁. As such, first flow path P₁ can be called a low-flow fluid path, and second path P₂ can be called a high-flow fluid path.

In some embodiments, the FADEC commands pressure regulating valve 22 and fill solenoid 24 to open in response to receiving a command to provide the secondary fuel to the gas turbine engine. In response to such opening of pressure regulating valve 22 and fill solenoid 24, fuel lines within fuel metering subsystem 14 will become pressurized. Such pressurization will cause check valve 28 to open so as to provide delivery of the secondary fuel to injector port 48. The FADEC receives a signal indicative of pressure from pressure sensor 26. The signal indicative of pressure sensor 26 is indicative of whether the fuel lines have been filled with the secondary fuel. For example, the FADEC can determine that the fuel lines have been filled with the secondary fuel in response to the signal received from pressure sensor 26 indicating that the pressure is greater than a predetermined threshold. In response to the signal indicating that the fuel lines have been filled with the secondary fuel, the FADEC can command fill solenoid 24 to close, leaving only steady-state delivery of the secondary fuel via first fuel path P₁.

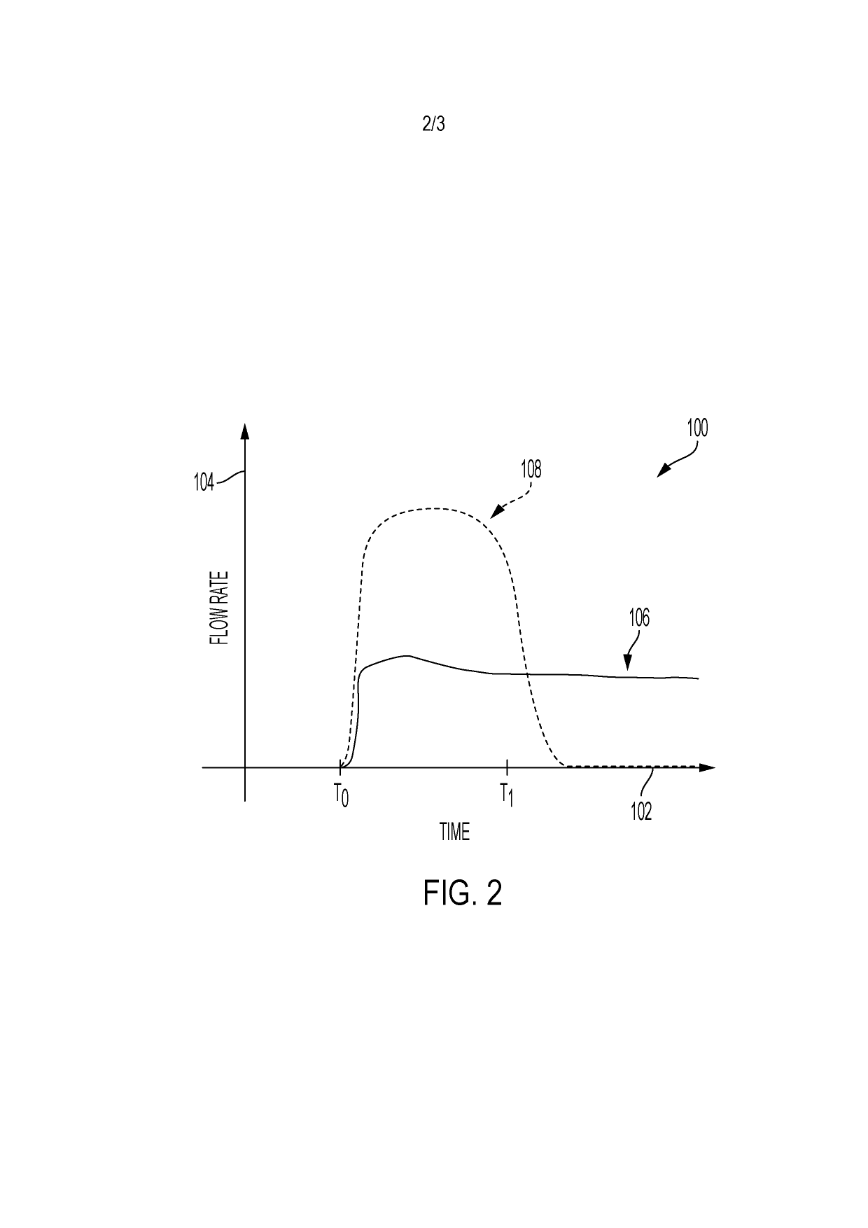

FIG. 2 is a graph of flow rates as a function of time for active fill operation of a secondary fuel. In FIG. 2, graph 100 includes horizontal axis 102, vertical axes 104, and flow-time relations 106 and 108. Horizontal axis 102 is indicative of time, and vertical axis 104 is indicative of flow rate. Flow-time relation 106 is indicative of flow rate of fuel within low-flow fluid path P₁, as depicted in FIG. 1. As depicted in graph 100, flow-time relation 106 is zero until time T₀, which is the time at which pressure regulating valve 22 and fill solenoid 24 open so as to permit flow of the secondary fuel to the gas turbine engine. At this time – T₀, fuel begins to flow through low-flow fluid path P₁. As depicted in graph 100, after time T₀, the flow through low-flow fluid path P₁ is substantially constant. Flow-time relation 108 is indicative of flow rate of fuel within high-flow fluid path P₂, as depicted in FIG. 1. As with flow-time relation 106, flow-time relation 108 is zero until time T₀. At this time – T₀, fuel begins to flow through high-flow fluid path P₂, but at a higher flow rate that that of flow-time relation 106. Then, at time T₁, fill solenoid 24 is closed in response to the signal indicative of pressure indicating that the fuel lines downstream of pressure-metering system 14 having been filled. After time T₁, flow through high-flow fluid path is reduced to zero, as indicated by flow-time relation 108.

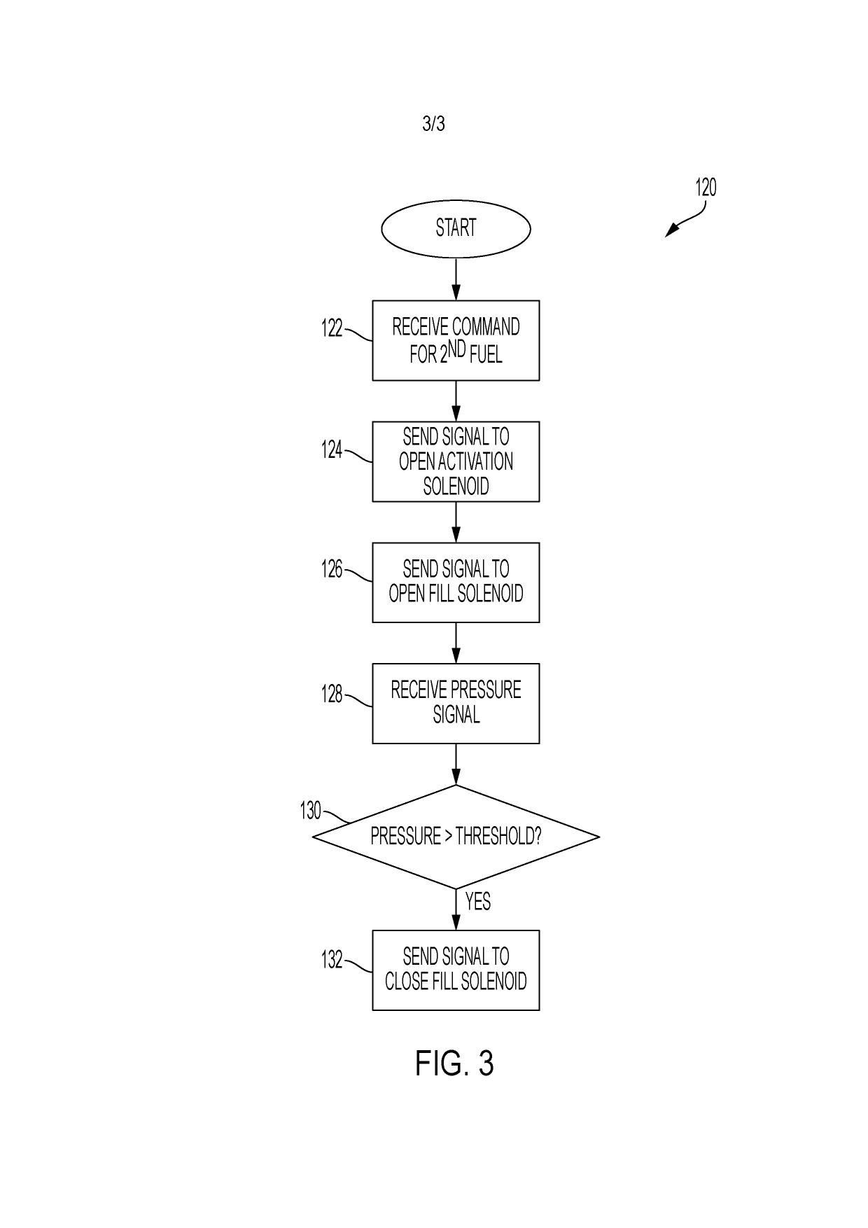

FIG. 3 is a flowchart depicting a method for actively filling fuel lines with a secondary fuel. In FIG. 3, method 120 depicts an example of operation of active fill control of a secondary fuel by a FADEC. Method 120 begins at step 122, where the FADEC receives a command to provide secondary fuel to the gas turbine engine. Method 120 then advances to step 124 where the FADEC sends a signal to activation solenoid 20. The signal sent to activation solenoid 20 is configured to cause activation solenoid 20 to open, which in turn causes shut-off valve 18 to provide fluid communication between the primary fuel source and first chamber 70 of secondary fuel reservoir 16. This results in pressurization of the primary fuel within first chamber 70 of secondary fuel reservoir 16. The secondary fuel within second chamber 72 of secondary fuel reservoir 16 is also pressurized via piston 64. The secondary fuel then flows from second chamber 72 of secondary fuel reservoir 16, through pressure regulating valve 22, to fill orifice 24 and metering orifice 30.

Method 120 then advances to step 126, where the FADEC sends a signal to fill solenoid 24. The signal sent to fill solenoid 24 is configured to cause fill solenoid 24 to open. Method 120 then advances to step 128, where the FADEC receives a signal indicative of pressure from pressure sensor 26. At step 130, the FADEC compares the signal received from pressure sensor 26 with a predetermined threshold. The FADEC remains at step 130 until the signal indicative of pressure exceeds the predetermined threshold. If, at step 130, the FADEC determines that the pressure at injector port 48 exceeds the predetermined threshold, method 120 advance to step 132, where the FADEC sends a signal to fill solenoid 24. The signal sent to fill solenoid 24 is configured to cause fill solenoid 24 to close.

### Discussion of Possible Embodiments

The following are non-exclusive descriptions of possible embodiments of the present invention.

Some embodiments relate to a secondary-fuel supply system with active fill capability. The secondary-fuel supply system includes a secondary-fuel reservoir having a piston separating a first chamber from a second chamber. The second chamber is configured to be filled with a secondary fuel. The first chamber is configured to be pressurized with a primary fuel, thereby causing the secondary fuel to be expelled from the second chamber. The secondary-fuel supply system includes a shut-off valve configured to selectively provide fluid communication between a pressurized primary fuel source and the first chamber of the secondary fuel reservoir. The secondary-fuel supply system includes a low-flow fluid path having a first flow resistance between the second chamber of the secondary-fuel reservoir and an injector port. The secondary-fuel supply system includes a high-flow fluid path in parallel with the low-flow fluid path. The high-flow fluid path has a fill solenoid having an open and a closed position. With the fill solenoid in the open position, a second flow resistance of the high-flow fluid path is less than the first flow resistance of the low-flow fluid path, thereby enabling active delivery of fuel in response to opening of the fill solenoid.

The secondary-fuel supply system of the preceding paragraph can optionally include, additionally and/or alternatively, any one or more of the following features, configurations and/or additional components:

A further embodiment of the foregoing secondary-fuel supply system, wherein the low-flow fluid path can have a metering orifice configured to limit fluid flow within the low-flow fluid path.

A further embodiment of any of the foregoing secondary-fuel supply systems, wherein the low-flow fluid path can also have a knockdown orifice in series with the metering orifice. The knockdown orifice can be configured to provide a differential pressure of fuel thereacross.

A further embodiment of any of the foregoing secondary-fuel supply systems, wherein the high-flow fluid path can also have a fill orifice in series with the fill solenoid. The fill orifice can be configured to meter the fuel at a higher flow rate than a flow rate as metered by the metering orifice.

A further embodiment of any of the foregoing secondary-fuel supply systems can further include a controller operatively coupled to the shut-off valve and the fill solenoid.

A further embodiment of any of the foregoing secondary-fuel supply systems, wherein, to provide secondary fuel to a gas turbine engine with active filling of secondary fuel lines, the controller can be configured to: i) pperatively cause the shut-off valve to open, thereby providing fluid communication between the pressurized primary fuel source and the first chamber of the secondary-fuel reservoir, which causes secondary fuel within the second chamber of the secondary-fuel reservoir to be pressurized via the piston of the secondary-fuel reservoir; and ii) operatively cause the fill valve to open thereby enabling active delivery of the secondary fuel.

A further embodiment of any of the foregoing secondary-fuel supply systems can further include an activation solenoid operatively coupled with the shut-off valve and configured to control operation of the shut-off valve.

A further embodiment of any of the foregoing secondary-fuel supply systems, wherein operatively causing the shut-off valve to open can include sending a signal to the activation solenoid, the signal causing the activation solenoid to control the shut-off valve to be in the open position.

A further embodiment of any of the foregoing secondary-fuel supply systems, wherein the shut-off valve can be a spool valve. The activation valve can be configured to control a position of a spool within the shut-off valve.

A further embodiment of any of the foregoing secondary-fuel supply systems, wherein the shut-off valve can be a normally-closed spool valve having a spring biasing the spool to a closed position.

A further embodiment of any of the foregoing secondary-fuel supply systems, wherein the activation solenoid can control a position of a spool within the shut-off valve by selectively providing fluid communication between the pressurized primary fuel source and a first control chamber within the shut-off valve.

A further embodiment of any of the foregoing secondary-fuel supply systems, wherein the spool within the shut-off valve can be configured to move to an open position in response to the activation solenoid providing fluid communication between the pressurized primary fuel source and a first control chamber within the shut-off valve.

A further embodiment of any of the foregoing secondary-fuel supply systems can further include a pressure sensor configured to sense the pressure of the secondary fuel at the injector port. The pressure sensed can be indicative of whether the secondary fuel lines have been filled.

A further embodiment of any of the foregoing secondary-fuel supply systems , wherein the controller can be configured to operatively cause the shut-off valve to close in response to the pressure sensed indicating that the secondary fuel lines have been filled.

A further embodiment of any of the foregoing secondary-fuel supply systems can further include a pressure regulating valve between the second chamber of the secondary-fuel reservoir and the low-flow and high-flow fluid paths. The pressure regulating valve can be configured to throttle pressure of the secondary fuel lines downstream therefrom in response to such pressures exceeding a specified pressure level for fuel injection.

A further embodiment of any of the foregoing secondary-fuel supply systems, wherein the pressure regulating valve can be a spool valve.

Some embodiments relate to a method for actively filling fuel lines with a secondary fuel. In the method, a command to provide a secondary fuel to the gas turbine engine is received by an engine controller. In response to receiving the command to provide a secondary fuel, the method performs the following steps: i) a signal configured to cause the shut-off valve to open is sent by the engine controller, thereby providing fluid communication between a pressurized primary fuel source and a first chamber of a secondary-fuel reservoir, which causes secondary fuel within a second chamber of the secondary-fuel reservoir to be pressurized via a piston positioned between the first and second chambers of the secondary-fuel reservoir; and ii) a signal configured to cause a fill solenoid to open is sent by the engine controller, thereby causing the secondary fuel to flow through a high-flow fluid path to the injector port. With the fill solenoid open, a second flow resistance of the high-flow fluid path is less than a first flow resistance of a low-flow fluid path that is in parallel with the high-flow fluid path, thereby enabling active delivery of fuel in response to opening of the fill solenoid.

The method of the preceding paragraph can optionally include, additionally and/or alternatively, any one or more of the following features, configurations and/or additional components:

A further embodiment of the foregoing method can further include: i) the engine controller receiving a signal indicative of pressure of a secondary fuel at the injector port from a pressure sensor; ii) the engine controller comparing the signal received from the pressure sensor with a predetermined threshold; and iii) the engine controller sending a signal configured to cause the fill solenoid to close in response to the pressure of the secondary fuel at the injector port exceeding the predetermined threshold.

A further embodiment of any of the foregoing methods, wherein the predetermined threshold can be indicative of filled secondary fuel lines downstream of the injector port.

A further embodiment of any of the foregoing methods can further include the engine controller receiving a command to stop providing the secondary fuel to the gas turbine engine wherein. In response to receiving the command to stop providing the secondary fuel, the engine controller can send a signal configured to cause the shut-off valve to close, thereby isolating the first chamber of a secondary-fuel reservoir from the pressurized primary fuel source.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A secondary-fuel supply system with active fill capability, the secondary-fuel supply system comprising:
a secondary-fuel reservoir having a piston separating a first chamber from a second chamber, the second chamber configured to be filled with a secondary fuel, the first chamber configured to be pressurized with a primary fuel, thereby causing the secondary fuel to be expelled from the second chamber;
a shut-off valve configured to selectively provide fluid communication between a pressurized primary fuel source and the first chamber of the secondary fuel reservoir;
a low-flow fluid path having a first flow resistance between the second chamber of the secondary-fuel reservoir and an injector port;
a high-flow fluid path in parallel with the low-flow fluid path, the high-flow fluid path including:
a fill solenoid having an open and a closed position, wherein, with the fill solenoid in the open position, a second flow resistance of the high-flow fluid path is less than the first flow resistance of the low-flow fluid path, thereby enabling active delivery of fuel in response to opening of the fill solenoid.

2. The secondary-fuel supply system of claim 1, wherein the low-flow fluid path includes:
a metering orifice configured to limit fluid flow within the low-flow fluid path.

3. The secondary-fuel supply system of claim 1, wherein the low-flow fluid path further includes:
a knockdown orifice in series with the metering orifice, the knockdown orifice configured to provide a differential pressure of fuel thereacross.

4. The secondary-fuel supply system of claim 1, wherein the high-flow fluid path further includes:
a fill orifice in series with the fill solenoid, the fill orifice configured to meter the fuel at a higher flow rate than a flow rate as metered by the metering orifice.

5. The secondary-fuel supply system of claim 1, further comprising:
a controller operatively coupled to the shut-off valve and the fill solenoid.

6. The secondary-fuel supply system of claim 5, wherein, to provide secondary fuel to a gas turbine engine with active filling of secondary fuel lines, the controller is configured to:
operatively cause the shut-off valve to open, thereby providing fluid communication between the pressurized primary fuel source and the first chamber of the secondary-fuel reservoir, which causes secondary fuel within the second chamber of the secondary-fuel reservoir to be pressurized via the piston of the secondary-fuel reservoir; and
operatively cause the fill valve to open thereby enabling active delivery of the secondary fuel.

7. The fuel-metering subsystem of claim 6, further comprising;
an activation solenoid operatively coupled with the shut-off valve and configured to control operation of the shut-off valve.

8. The fuel-metering subsystem of claim 7, wherein operatively causing the shut-off valve to open includes:
sending a signal to the activation solenoid, the signal causing the activation solenoid to control the shut-off valve to be in the open position.

9. The fuel-metering subsystem of claim 8, wherein the shut-off valve is a spool valve, wherein the activation valve is configured to control a position of a spool within the shut-off valve.

10. The fuel-metering subsystem of claim 9, wherein the shut-off valve is a normally-closed spool valve having a spring biasing the spool to a closed position.

11. The fuel-metering subsystem of claim 10, wherein the activation solenoid is configured to control a position of a spool within the shut-off valve by selectively providing fluid communication between the pressurized primary fuel source and a first control chamber within the shut-off valve.

12. The fuel-metering subsystem of claim 11, wherein the spool within the shut-off valve is configured to move to an open position in response to the activation solenoid providing fluid communication between the pressurized primary fuel source and a first control chamber within the shut-off valve.

13. The fuel-metering subsystem of claim 6, further comprising:
a pressure sensor configured to sense the pressure of the secondary fuel at the injector port, the pressure sensed indicative of whether the secondary fuel lines have been filled.

14. The secondary-fuel supply system of claim 13, wherein the controller is configured to:
operatively cause the shut-off valve to close in response to the pressure sensed indicating that the secondary fuel lines have been filled.

15. The secondary-fuel supply system of claim 1, further comprising:
a pressure regulating valve between the second chamber of the secondary-fuel reservoir and the low-flow and high-flow fluid paths, the pressure regulating valve configured to throttle pressure of the secondary fuel lines downstream therefrom in response to such pressures exceeding a specified pressure level for fuel injection.

16. The secondary-fuel supply system of claim 15, wherein the pressure regulating valve is a spool valve.

17. A method for actively filling fuel lines with a secondary fuel, the method comprising:
receiving a command to provide a secondary fuel to a gas turbine engine, wherein, in response to receiving the command to provide a secondary fuel, the method performs the following steps:
sending a signal configured to cause the shut-off valve to open, thereby providing fluid communication between a pressurized primary fuel source and a first chamber of a secondary-fuel reservoir, which causes secondary fuel within a second chamber of the secondary-fuel reservoir to be pressurized via a piston positioned between the first and second chambers of the secondary-fuel reservoir; and
sending a signal configured to cause a fill solenoid to open, thereby causing the secondary fuel to flow through a high-flow fluid path to the injector port, wherein, with the fill solenoid open, a second flow resistance of the high-flow fluid path is less than a first flow resistance of a low-flow fluid path that is in parallel with the high-flow fluid path, thereby enabling active delivery of fuel in response to opening of the fill solenoid.

18. The method of claim 17, further comprising:
receiving a signal indicative of pressure of a secondary fuel at the injector port from a pressure sensor;
comparing the signal received from the pressure sensor with a predetermined threshold; and
sending a signal configured to cause the fill solenoid to close in response to the pressure of the secondary fuel at the injector port exceeding the predetermined threshold.

19. The method of claim 18, wherein the predetermined threshold is indicative of filled secondary fuel lines downstream of the injector port.

20. The method of claim 17, further comprising:
receiving a command to stop providing the secondary fuel to the gas turbine engine wherein, in response to receiving the command to stop providing the secondary fuel, the method performs the following step:
sending a signal configured to cause the shut-off valve to close, thereby isolating the first chamber of a secondary-fuel reservoir from the pressurized primary fuel source.
